(19) United States
(12) Patent Application Publication
(10) Pub. No.: US 2025/0301379 A1
(43) Pub. Date: Sep. 25, 2025

(54) METHOD AND APPARATUS FOR CELL RESELECTION WITH SLICES IN WIRELESS COMMUNICATION SYSTEMS

(71) Applicant: Samsung Electronics Co., Ltd., Suwon-si, Gyeonggi-do (KR)

(72) Inventors: Aby Kanneath ABRAHAM, Bangalore (IN); Sangyeob JUNG, Suwon-si (KR)

(21) Appl. No.: 18/863,521

(22) PCT Filed: May 8, 2023
(86) PCT No.: PCT/KR2023/006205

§ 371 Date: Nov. 6, 2024

(30) Foreign Application Priority Data
May 6, 2022 (IN) 202241026510
Apr. 24, 2023 (IN) 202241026510

(51) Int. Cl. H04W 36/08; H04W 36/00

(52) U.S. Cl. CPC H04W 36/08; H04W 36/0061; H04W 36/00835

(57) ABSTRACT

The disclosure relates to a 5G or 6G communication system for supporting a higher data transmission rate. The present disclosure relates to a method and apparatus for cell reselection with slices in wireless network. Embodiment herein is to provide a method for reselecting a cell with slices in a wireless network. The method comprises receiving a first slice information list in a frequency from a network apparatus (201) in the wireless network. The first slice information list includes information to identify a list of cells of a first slice group. A UE (102) receives a second slice information list that includes the information to identify the list of cells of a second slice group. Further, identifying one of allowed cell list and excluded cell list of the first slice group and second slice group based on the first slice information list and the second slice information list. Also, performing a slice-based cell reselection based on determining a slice-based cell reselection priority using identified one of the allowed cell list and the excluded cell list of the first slice group and the second slice group.

### TECHNICAL FIELD

The present invention relates to a wireless network. More particularly relates to a system and method for cell reselection with slices in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In general, a most prominent feature of a 5th Generation (5G) networks lies in adopting network slicing for a radio access networks (RANs) and a core networks (CNs). This is intended for bundling up network resources and network functions into a single independent network slice depending on individual services, allowing for application of network system function and resource isolation, customization, independent management and orchestration to mobile communication network archi-tectures. The use of such network slicing enables offering 5G services in an independent and flexible way by selecting and combining 5G system network functions according to services, users, business models, or the like.

In existing mechanism, for a slice-based cell reselection, a gNodeB (gNB) broadcasts a sliceCellListNR that contains a Physical Cell Identity (PCI) list information. The PCI list information includes one of a sliceAllowedCellListNR and a sliceExcluded-CellListNR. The PCI list information includes a lot of repeated information and causes a large overhead. For each slice group, a serving cell broadcast (or gNB provides information to the UE in dedicated signaling) the PCI list information related to a PCI of cells that support the slice group or the PCI of the cells that do not support the slice group or that supports the slice group. In such a scenario, the repeated information in the PCI list information for each slice group leads to a big signaling overhead.

Thus, it is desired to address the above-mentioned disadvantages or other shortcomings or at least provide a useful alternative to overcome the inter-device connection setup problems and synchronization problems.

### DISCLOSURE OF INVENTION

### Technical Problem

The present invention has been made to address at least the above problems and/or disadvantages and to provide at least the advantages described below. Accordingly, an aspect of the present invention provides a method and apparatus for performing cell re-selection with slices.

The principal object of the embodiments herein is to provide a system and method for cell reselection with slices in a wireless network. The proposed method relates to broadcasting a slice information list to a User Equipment (UE). During transmission of the slice information list to the UE, the wireless network avoids a repeated information contained in the slice information list to reduce the signaling overhead.

Another object of the embodiments herein is to provide a method to identify the slice information list to be used for a slice-based cell reselection among different Public Land Mobile Network (PLMN).

Yet another object of the embodiments herein is to provide a method for determining a cell reselection priority of a serving frequency for the slice-based cell reselection.

### Solution to Problem

In one aspect of the objects are achieved by providing a method for reselecting a cell with slices in a wireless network. The method includes receiving, by the UE, a first slice information list in a frequency from a network apparatus in the wireless network. The first slice information list includes information to identify a list of cells of a first slice group. The method includes receiving a second slice information list in the frequency from the network apparatus in the wireless network. The second slice information list includes the information to identify the list of cells of a second slice group. Further, the method includes identifying one of allowed cell list and excluded cell list of the first slice group and second slice group based on the first slice information list and the second slice information list. Also, the method includes performing a slice-based cell reselection based on determining a slice-based cell reselection priority using identified one of the allowed cell list and the excluded cell list of the first slice group and the second slice group.

In an embodiment, the first slice information list and the second slice information list further include a slicegroup identifier, a slice-based cell reselection priority, and a slice-based cell reselection sub-priority.

In an embodiment, the method includes detecting the received second slice information list includes list of PCI ranges and an index associated with the list of PCI ranges. Further, the method includes detecting the received first slice information list includes the index associated with the list of PCI ranges. Also, the method includes identifying one of the allowed cell list and the excluded cell list of the first slice group based on the index detected in the first slice information list and the index associated with the list of PCI ranges detected in the second slice information list. The list of PCI ranges for one of the allowed cell list and the excluded cell list in the first slice information list is the index associated with the list of PCI ranges detected in the second slice information list. The index associated with the list of PCI ranges detected in the second slice information list is equal to the index detected in the first slice information list.

In an embodiment, the method includes detecting the received second slice information list include the list of PCI ranges and a slice group identifier. Further, the method includes detecting the first slice information list includes a mapped slice group identifier. The mapped slice group identifier is equal to the slice group identifier of the second slice group. Also, the method includes identifying one of the allowed cell list and the excluded cell list of the first slice group based on the second slice information list. The allowed cell list and the excluded cell list of the first slice group is similar to the allowed cell list and excluded cell list of the second slice group.

In an embodiment, the method includes detecting the second slice information list includes the list of PCI ranges and a tracking area identity. Further, the method includes detecting the first slice information list includes the tracking area identity that is equal to the tracking area identity in the second slice information list. Also, the method includes identifying one of the allowed cell list and the excluded cell list of the first slice group based on the second slice information list. The allowed cell list or the excluded cell list of the first slice group is similar to the one allowed cell list and excluded cell list of the second slice group.

In an embodiment, the method includes detecting one of the first slice information list and the second slice information list includes a serving frequency and one of the allowed cell list and the excluded cell list includes a serving cell.

In an embodiment, the first slice information list and the second slice information list are received in broadcast signaling.

In an embodiment, the method includes detecting one of the first slice information list and the second slice information list includes one of registered Public Land Mobile Network (PLMN), equivalent PLMN and different PLMNs. A PLMN corresponds to the network of an operator, which is shared with other operators. Further, the method includes performing the slice-based resection by determining the slice-based priority using the first slice information list and the second slice information list for at least one of registered PLMN and the equivalent PLMN.

In another aspect of the objects are achieved by providing a method for reselecting the cell with slices in the wireless network. The method includes creating, by the network apparatus, the first slice information list for the first slice group and the second slice information list for the second slice group. The first slice information list and the second slice information list include information to identify the at least one allowed cell list and the excluded cell list. Further, the method includes sending the first slice information list and the second slice information list in broadcast signaling.

In an embodiment, the method includes creating the second slice information list includes the list of PCI ranges and the index associated with the list of PCI ranges. Further, the method includes determining the first slice information list includes the index associated with the list of PCI ranges, when the index of the first slice information list is equal to the index in the second slice information list, at least one of the allowed cell list and the excluded cell list is the same for the first slice group and second slice group. Also, the method includes sending the first slice information list and the second slice information list in the broadcast signaling.

In an embodiment, the method includes creating the second slice information list includes the list of PCI ranges and the slice group identifier. Further, the method includes determining the first slice information list includes the mapped slice group identifier, when the mapped slice group identifier is equal to the slice group identifier of the second slice group, at least one of the allowed cell list and the excluded cell list is the same for the first slice group and second slice group. Also, the method includes sending the first slice information list and the second slice information list in the broadcast signaling.

In an embodiment, the method includes creating the second slice information list includes the list of PCI ranges, and the tracking area identity. Further, the method includes creating the first slice information list includes the tracking area identity when at least one of the allowed cell list and the excluded cell list is same for the first slice group and second slice group. Also, the method includes sending the first slice information list and the second slice information list in the broadcast signaling.

In an embodiment, the method includes prioritizing the slice-based cell reselection. The method includes creating the first slice information list and the second slice information list. The first slice information list or the second slice information list includes the serving frequency and one of the allowed cell list and the excluded cell list includes a serving cell. Also, the method includes sending one of the first slice information list and the second slice information list in the frequency to the UE for reselecting the slice-based cell.

Yet another aspect of the objects is achieved by the UE for reselecting the cell with slices in the wireless network. The UE includes a memory, a processor, and a UE controller. The processor coupled to the memory. The UE controller coupled to the memory and the processor. The UE controller receives the first slice information list in the frequency from the network apparatus in the wireless network. The first slice information list includes the information to identify the list of cells of the first slice group. The UE controller receives the second slice information list in the frequency from the network apparatus in the wireless network. The second slice information list includes the information to identify the list of cells of the second slice group. The UE controller identifies one of the allowed cell list and the excluded cell list of the first slice group and the second slice group based on the first slice information list and the second slice information list. Further, the UE controller performs the slice-based cell reselection by determining the slice-based cell reselection priority using identified one of the allowed cell list and the excluded cell list of the first slice group and the second slice group.

Yet another aspect of the objects is achieved by the network apparatus for reselecting the cell with slices in the working network. The network apparatus includes a memory, a processor coupled to the memory, and a network apparatus controller coupled to the memory, and the processor. The network apparatus controller creates the first slice information list for the first slice group and the second slice information list for the second slice group. The first slice information list and the second slice information list include information to identify the at least one allowed cell list and the excluded cell list. The network apparatus controller sends the first slice information list and the second slice information list in the broadcast signaling.

These and other aspects of the embodiments herein will be better appreciated and understood when considered in conjunction with the following description and the accompanying drawings. It is understood, however, that the following descriptions, while indicating preferred embodiments and numerous specific details thereof, are given by way of illustration and not of limitation. Many changes and modifications be made within the scope of the embodiments herein without departing from the spirit thereof, and the embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for method and network for performing cell reselection with slices.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a block diagram of a UE, according to the embodiments as disclosed herein;

FIG. 2 illustrates a block diagram of a network apparatus, according to the embodiments as disclosed herein;

FIG. 3 illustrates a flow chart illustrating a method for performing a slice-based cell reselection, according to the embodiments as disclosed herein; and

FIG. 4 illustrates a flow chart illustrating a method for sending a slice information list, according to the embodiments as disclosed herein.

FIG. 5 illustrates a structure of a UE in a wireless communication system to which embodiments of the disclosure can be applied; and

FIG. 6 illustrates a structure of a base station in a wireless communication system to which embodiments of the disclosure can be applied.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

The accompanying drawings are used to help easily understand various technical features and it should be understood that the embodiments presented herein are not limited by the accompanying drawings. As such, the proposed method should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments disclose a method for reselecting a cell with slices in a wireless network. The method includes receiving, by the UE, a first slice information list in a frequency from a network apparatus in the wireless network. The first slice information list includes information to identify a list of cells of a first slice group. The method includes receiving a second slice information list in the frequency from the network apparatus in the wireless network. The second slice information list includes the information to identify the list of cells of a second slice group. Further, the method includes identifying one of allowed cell list and excluded cell list of the first slice group and second slice group based on the first slice information list and the second slice information list. Also, the method includes performing a slice-based cell reselection based on determining a slice-based cell reselection priority using identified one of the allowed cell list and the excluded cell list of the first slice group and the second slice group.

Accordingly, the embodiments disclose a method for reselecting the cell with slices in the wireless network. The method includes creating, by the network apparatus, the first slice information list for the first slice group and the second slice information list for the second slice group. The first slice information list and the second slice information list include information to identify the at least one allowed cell list and the excluded cell list. Further, the method includes sending the first slice information list and the second slice information list in broadcast signaling.

Accordingly, the embodiments disclose the UE for reselecting the cell with slices in the wireless network. The UE includes a memory, a processor, and a UE controller. The processor coupled to the memory. The UE controller coupled to the memory and the processor. The UE controller receives the first slice information list in the frequency from the network apparatus in the wireless network. The first slice information list includes the information to identify the list of cells of the first slice group. The UE controller receives the second slice information list in the frequency from the network apparatus in the wireless network. The second slice information list includes the information to identify the list of cells of the second slice group. The UE controller identifies one of the allowed cell list and the excluded cell list of the first slice group and the second slice group based on the first slice information list and the second slice information list. Further, the UE controller performs the slice-based cell reselection by determine the slice-based cell reselection priority using identified one of the allowed cell list and the excluded cell list of the first slice group and the second slice group.

Accordingly, the embodiments disclose the network apparatus for reselecting the cell with slices in the working network. The network apparatus includes a memory, a processor coupled to the memory, and a network apparatus controller coupled to the memory, and the processor. The network apparatus controller creates the first slice information list for the first slice group and the second slice information list for the second slice group. The first slice information list and the second slice information list include information to identify the at least one allowed cell list and the excluded cell list. The network apparatus controller sends the first slice information list and the second slice information list in the broadcast signaling.

In conventional methods, the wireless network broadcasts a slice information list for each slice group to the UE, where the slice information list includes the list of PCI range. The list of PCI range includes one of a slice allowed cell list and a slice excluded cell list. The UE receives the list of PCI ranges which is related to a PCI of cells that support the slice group or the PCI of the cells that do not support the slice group from the wireless network. Therefore, the UE receiving the list of PCI ranges for each slice group lead to a big signaling overhead due to a lot of repeated information contained in the list of PCI ranges.

Unlike the conventional methods, the wireless network transmits the second slice information list that includes information to identify a list of cells of a second slice group to the UE and transmits the first slice information list that includes the information to identify the list of cells of a first slice group to the UE. The wireless network requests the UE to use the information of the second slice information list to identify the first slice group to reduce the lot of repeated information which is leads to signaling overhead.

A network slice always consists of a RAN part and a CN part. A network slicing relies on the principle to handle traffic for different slices by different Protocol Data Unit (PDU) sessions. The network realizes the different network slices by scheduling and also by providing different L1/L2 configurations.

The network slicing is a concept to allow differentiated treatment depending on each customer requirements. By slicing, it is possible for a Mobile Network Operators (MNO) to consider customers as belonging to different tenant types with each having different service requirements that govern in terms of what slice types each tenant is eligible to use based on a Service Level Agreement (SLA) and subscriptions.

Some slices are available only in a part of a network. An (Next Generation-Radio Access Network (NG-RAN) supports a Single Network Slice Selection Assistance Information (S-NSSAI(s)) that is configured by an Operations, Administration and Maintenance (OAM). An awareness in the NG-RAN of slices supported in cells of its neighbors are beneficial for inter-frequency mobility in connected mode and assumed that the slice availability does not change within a UE's registration area. The NG-RAN and a 5G core are responsible to handle a service request for the slice that may or may not be available in a given area. Admission or rejection of access to the slice is depend by factors such as support for the slice, availability of resources, a support of the requested service by NG-RAN. When the UE is associated with multiple slices simultaneously, only one signaling connection is maintained and for intra-frequency cell reselection, the UE always tries to camp on the best cell.

Some of the slices are supported only in some frequencies. An NR network uses dedicated priorities to control the frequency on which the UE camps. In the NR network, the slice specific prioritization is introduced. A serving cell broadcasts slice information including the slice support in a serving as well as neighboring frequencies, a slice specific priority for serving as well as neighboring frequencies, details on the slice availability in neighboring cells, etc. and also some frequencies which is not be associated with any slices. The UE consider slice priorities of the slices that it needs/supports along with frequency priorities for the slices during cell reselection.

According to a Third Generation Partnership Project (3GPP) specification, the cell reselection is the process that identifies the cell that the UE should camp on when the UE is in non-connected state—i.e., RRC_IDLE and RRC_INACTIVE. It is based on cell reselection criteria. An Inter-frequency reselection is based on absolute priorities where the UE tries to camp on highest priority frequency available. It involves measurements of the serving and neighbor cells-Cell reselection is speed dependent and in multi-beam operations, the cell quality is derived amongst the beams corresponding to the same cell. A number of cells may be grouped into Tracking Areas (TA).

Absolute priorities of different NR frequencies or inter-Radio Access Technology (RAT) frequencies is provided to the UE in system information, in a RRC Release message, or by inheriting from another RAT at the inter-RAT cell (re) selection. In a scenario of the system information, an NR frequency or the inter-RAT frequency is listed without providing a priority (i.e., the field cellReselectionPriority is absent for that frequency). When the priorities are provided in dedicated signaling, the UE ignore all the priorities provided in the system information. The UE receives an information element known as deprioritisationReq from the wireless network which informs the UE to deprioritize a set of the frequencies. When the UE is in camped on any cell state, the UE shall only apply the priorities provided by the system information from a current cell, and the UE preserves priorities provided by a dedicated signaling and deprioritisationReq received in the RRC Release unless specified otherwise. When the UE is configured to perform a NR side link communication or a V2X side link communication and consider the frequencies providing in an intra-carrier and inter-carrier configurations which are having equal priority in the cell reselection.

The absolute priorities are used during the cell reselection, when a neighbor frequency has a lower or an equal priority than the serving frequency, the UE measures the frequencies for the cell reselection only when the serving cell goes below certain threshold decided by the network. If the neighbor frequency has a higher priority than the serving frequency, the UE measures those frequencies irrespective of the serving frequency thresholds. The UE may further relax measurements based on the mobility of the UE or based on the distance of the UE from the serving cell. The network provides thresholds and conditions for the UE to the relax measurements. These conditions can be different for low priority frequencies and high priority frequencies.

The UE performs cell reselection evaluation based on different thresholds and different conditions depending on whether the neighbor frequency is having lower/equal/higher priority than the serving frequency. When there are multiple neighbor cells that satisfy cell reselection evaluation criteria, the UE reselects to the neighboring cells belonging to the higher priority frequency. All these information is provided in the system information messages.

When the UE camped normally (i.e., UE is camped to its network a network where it has normal services), the UE executes the cell reselection evaluation process on the following triggers:
i. UE internal triggers are done to meet performance requirements. The UE internal triggers such as to perform cell reselection evaluation process every few milliseconds based on how often UE wakes up when it is in a non-connected state.
ii. When information on the system information used for the cell reselection evaluation procedure has been modified.

In slice aware cell reselection, the UE prioritizes frequencies which support one or more slices. A Network Slice AS Groups (NSAG) or the slice groups are a group that is associated to one or more slices. The UE receives information about NSAG from the core network. A core network function called Access and Mobility management Function (AMF) is responsible for providing this information to the UE. When the UE has indicated that the UE supports the NSAG, AMF may configure the UE with NSAG Information for one or more Network Slice Selection Assistance Information (S-NSSAIs, each S-NSSAI may identify a slice uniquely) in the Configured NSSAI based on including the NSAG Information in Non Access Stratum messages such as Registration Accept message or UE Configuration Command message. The AMF indicates in the NSAG Information in which TA a specific NSAG association to the S-NSSAI(s) is valid when the AMF provides in the UE configuration the NSAG value which is used in different TAs with a different association with NSSAIs. The configuration AMF provides includes at least the NSAGs for the UE for the TAs of the Registration Area (A registration area is an area where a UE can move in non-connected mode without updating the core network).

The UE stores and consider the received NSAG Information, valid for the Registered PLMN until: the UE receives new NSAG information in a Registration Accept message or the UE Configuration Command message in the PLMN; or the UE receives a Configured NSSAI without any NSAG information in the PLMN.

An (New Radio User Equipment Rdio Resource Control (NR UE RRC) may receive slicegroup, and/or slice priority associated with the slice from the non-access stratum (NAS) layer.

The NR UE RRC also may receive the list of sliceInformation, sliceInformation including an identifier for the slice (or a group of slices known as slicegroup) and list of frequencies and priority applicable for individual frequencies for the slice. There can be frequencies without priorities in the sliceInformation and such slices/slice groups may be considered as the lowest frequency priority for this slice/slice group.

-- ASN1START
-- TAG-FREQPRIORITYLISTNRSLICING-START
FreqPriorityListNRSlicing-r17 ::= SEQUENCE (SIZE (0..maxFreq)) OF
FreqPriorityNRSlicing-r17

| | |
|---|---|
| FreqPriorityNRSlicing-r17 ::= | SEQUENCE { |
| sliceInformationList-r17 | SliceInformationList-r17 |

OPTIONAL, -- Need R
...
}

| | |
|---|---|
| SliceInformationList-r17 : := | SEQUENCE (SIZE |

(1..maxSliceInformation-r17)) OF SliceInformation-r17

| | |
|---|---|
| SliceInformation-r17 ::= | SEQUENCE { |
| sliceGroupID-r17 | SliceGroupID-r17, |
| cellReselectionPriority-r17 | CellReselectionPriority |

OPTIONAL, -- Need R

| | |
|---|---|
| cellReselectionSubPriority-r17 | CellReselectionSubPriority |

OPTIONAL, -- Need R

| | |
|---|---|
| sliceCellListNR-r17 | CHOICE { |
| sliceAllowCellListNR-r17 | SliceCellListNR-r17, |
| sliceExcludeCellListNR-r17 | SliceCellListNR-r17 |

```
  }
  OPTIONAL, -- Need R
  ...
}
```

| | |
|---|---|
| SliceGroupID-r17 ::= | BIT STRING (SIZE(8)) -- The size is FFS, |

depends on slice group granulartiy

| | |
|---|---|
| SliceCellListNR-r17 ::= | SEQUENCE (SIZE (1..maxCellSlice-r17)) OF PCI- |

Range
-- TAG-FREQPRIORITYLISTNRSLICING-STOP
-- ASN1STOP

TABLE 1
FreqPriorityListNRSlicing field descriptions

FreqPriorityListNRSlicing
Indicates the list of frequency priority information
for frequencies. The 1^{st} entry in the
list corresponds to the current frequency
(referring SIB2), the 2^{nd} entry in the list
corresponds to the first frequency indicated
by the InterFreqCarrierFreqList in SIB4, and the 3^{rd} entry in
the list corresponds to the second frequency indicated by the
InterFreqCarrierFreqList in SIB4, and so on.
sliceAllowCellListNR
Indicates the list of allow-listed neighbouring cells
for slicing. If present, cells not listed in this
list do not support the corresponding sliceGroup-frequency pair.
sliceCellListNR
Indicates the list of allow-list or exclude-
listed neighbour cells for slicing. If
sliceInformation-r17 corresponds to the current
frequency, this field should be absent. FFS if
the field can be provided in RRCRelease.
sliceExcludeCellListNR
Indicates the list of exclude-listed neighbouring
cells for slicing. If present, cells not
listed in this list support the corresponding
slice sliceGroup-frequency pair.

When the UE performs slice-based cell reselection, the priority used for cell reselection is a combination of both slice priority/NSAG priority received from NAS and frequency priority received from RRC.

There are two ways by which sliceInformation (for e.g. FreqPriorityNRSlicing) is received by the UE. The first way is based on broadcast signaling (SIB16) and other way is based on dedicated signaling in RRC messages like RRC release. System Information Block (SIB16) structure is given as below:

-- ASN1START
-- TAG-SIB16-START

| | |
|---|---|
| SIB16-r17 ::= | SEQUENCE { |
| freqPriorityListNRSlicing-r17 | FreqPriorityListNRSlicing-r17 |

OPTIONAL, -- Need R

| | |
|---|---|
| lateNonCriticalExtension | OCTET STRING |

```
  OPTIONAL,
    ...
}|
-- TAG-SIB16-STOP
-- ASN1STOP
```

RRC Release may include cellReselectionPriorities as below.

| | |
|---|---|
| CellReselectionPriorities ::= | SEQUENCE { |
| freqPriorityListEUTRA | FreqPriorityListEUTRA |

OPTIONAL, -- Need M

| | |
|---|---|
| freqPriorityListNR | FreqPriorityListNR |

OPTIONAL, -- Need M

| | |
|---|---|
| t320 | ENUMERATED {min5, min10, min20, |

```
  min30, min60, min120, min180, spare1} OPTIONAL, -- Need R
    ...,
    [[
```

| | |
|---|---|
| freqPriorityListNRSlicing-r17 | FreqPriorityListNRSlicing-r17 |

```
  OPTIONAL -- Need M
    ]]
}
```

Slice Aware Cell Reselection Procedure: As per the 3GPP specification, the UE derives slice specific cell reselection priorities when it performs the slice-based cell re-selection as below:

The UE derives re-selection priorities for the slice-based cell re-selection by using:
a list of prioritized slice groups (NSAG) provided by NAS in priority order,
sliceInformation per frequency with sliceSpecificCellReselectionPriority per slice group, when provided system information and/or dedicated signaling,
cellReselectionPriority per frequency provided in system information and/or dedicated signaling.

The UE considers an NR frequency to support a slice group if
the NR frequency is included in sliceInformation and supports the said slice group; and
the cell is either listed in the sliceAllowCellListNR (when provided in system information of the serving cell and/or dedicated signaling); or
the cell is not listed in the sliceExcludeCellListNR (when provided in system information of the serving cell and/or dedicated signaling).

The UE shall derive re-selection priorities for the slice-based cell re-selection according to the following rules:
Frequencies that support at least one prioritized slice group received from the NAS have higher re-selection priority than frequencies that support no prioritized slice groups.
Frequencies that support at least one slice group are prioritized in the order of the NAS-provided priority for the highest prioritized slice group of the frequency.
Among the frequencies that support the same highest prioritized slice group, the frequencies are prioritized in the order of their per slice group sliceSpecificCellReselectionPriority.
Frequencies that support a prioritized slice group and that indicate per slice group sliceSpecificCellReselectionPriority have higher re-selection priority than frequencies that support this prioritized slice group without indicating per slice group sliceSpecificCellReselectionPriority.
Frequencies that support no prioritized slice group are prioritized in the order of their cellReselectionPriority.

Further during the cell reselection, the slice specific cell reselection priority is re-derived when the best cell doesn't support highest priority frequency.

The UE performing the slice-based cell reselection when a cell fulfills the above criteria for cell reselection based on the re-selection priority for the frequency and slice group derived according to above rules, but this cell does not support the slice group based on above conditions, the UE shall re-derive a re-selection priority for the frequency by considering the slice groups supported by this cell (rather than those of the corresponding NR frequency) according to clause above rules. This reselection priority is used until the highest ranked cell changes on the frequency, or new slice or slice group priorities are received from NAS. The UE ensures the cell reselection criteria above are fulfilled based on the newly derived priorities.

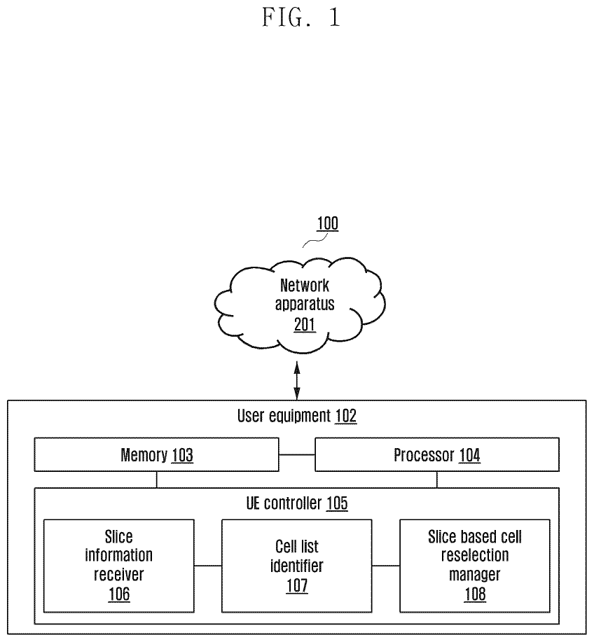

Referring now to the drawings and more particularly to FIGS. 1 through 4, where similar reference characters denote corresponding features consistently throughout the figure, these are shown preferred embodiments.

FIG. 1 is a block diagram of a UE (102), according to the embodiments as disclosed herein. The UE includes a memory (103), a processor (104), and a UE controller (105). The memory (103) coupled to the processor (104). The UE controller (105) coupled to the memory (103) and the processor (104). The UE controller (105) receives a first slice information list in a frequency from a network apparatus in the wireless network. The first slice information list includes an information to identify a list of cells of a first slice group. Also, the UE controller (105) receives a second slice information list in the frequency from the network apparatus in the wireless network. The second slice information list includes the information to identify the list of cells of a second slice group. Further, the UE controller (105) identifies allowed cell list or excluded cell list of the first slice group and the second slice group based on the first slice information list and the second slice information list. The UE controller (105) performs a slice-based cell reselection by determine a slice-based cell reselection priority using identified one of the allowed cell list and the excluded cell list of the first slice group and the second slice group.

In an embodiment, further the first slice information list and the second slice information list include a slicegroup identifier, a slice-based cell reselection priority, and a slice-based cell reselection sub-priority.

The memory (103) is configured to store instructions to be executed by the processor (104). The memory (103) includes non-volatile storage elements. Examples of such non-volatile storage elements includes magnetic hard discs, optical discs, floppy discs, flash memories, or forms of Electrically Programmable Memories (EPROM) or Electrically Erasable and Programmable Memories (EEPROM). In addition, the memory (103) in some examples, be considered a non-transitory storage medium. The term “non-transitory” indicates that the storage medium is not embodied in a carrier wave or a propagated signal. The term “non-transitory” is not be interpreted that the memory (103) is non-movable. In some examples, the memory (103) is configured to store larger amounts of information. In certain examples, a non-transitory storage medium stores data that can, over time, change (e.g., in Random Access Memory (RAM) or cache).

The processor (104) includes one or a plurality of processors. The one or the plurality of processors is a general-purpose processor, such as a Central Processing Unit (CPU), an Application Processor (AP), or the like, a graphics processing unit such as a Graphics Processing Unit (GPU), a Visual Processing Unit (VPU), and/or an AI-dedicated processor such as a Neural Processing Unit (NPU). The processor (104) includes multiple cores and is configured to execute the instructions stored in the memory (103).

In an embodiment, the UE controller (105) detects the received second slice information list that includes list of PCI ranges and an index associated with the list of PCI ranges. Further, the UE controller (105) detects the received first slice information list that includes the index associated with the list of PCI ranges. The UE controller (105) identifies the allowed cell list or the excluded cell list of the first slice group based on the index detected in the first slice information list and the index associated with the list of PCI ranges detected in the second slice information list. The list of PCI ranges for the allowed cell list or the excluded cell list in the first slice information list is the index associated with the list of PCI ranges detected in the second slice information list. The index associated with the list of PCI ranges detected in the second slice information list is equal to the index associated with the list of PCI ranges detected in the first slice information list.

In another embodiment, the UE controller (105) detects the received second slice information list that includes the list of PCI ranges and a slice group identifier. The UE controller (105) detect that the first slice information list includes a mapped slice group identifier. The mapped slice group identifier is equal to the slice group identifier of the second slice group. Further, the UE controller (105) identifies the allowed cell list or the excluded cell list of the first slice group based on the second slice information list. The allowed cell list or the excluded cell list of the first slice group is similar to the allowed cell list or the excluded cell list of the second slice group.

In another embodiment, the UE controller (105) detects the second slice information list that includes the list of PCI ranges and a tracking area identity. The UE controller (105) detects the first slice information list that includes the tracking area identity that is equal to the tracking area identity in the second slice information list. The UE controller (105) identifies the allowed cell list or the excluded cell list of the first slice group based on the second slice information list. The allowed cell list or the excluded cell list of the first slice group is similar to the allowed cell list or the excluded cell list of the second slice group.

The UE controller (105) detects the first slice information list or the second slice information list that includes a serving frequency and the allowed cell list or the excluded cell list. The allowed cell list or the excluded cell list includes a serving cell where the UE (102) is camped. The UE (102) receives the first slice information list and the second slice information list are received in broadcast signaling.

The UE (102) use the first slice group or the second slice group supported by the serving cell to determine the slice-based cell reselection priority for the serving frequency.

Further, the UE controller (105) detects the first slice information list or the second slice information list that includes registered Public Land Mobile Network (PLMN) or equivalent PLMN or different PLMNs. The UE controller (105) performs the slice-based resection by determining the slice-based priority using the first slice information list and the second slice information list for the registered PLMN or the equivalent PLMN.

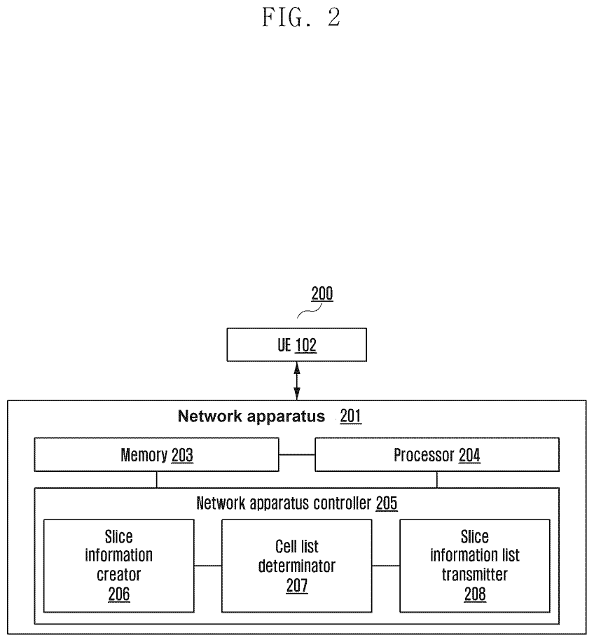

FIG. 2 is a block diagram of the network apparatus (201), according to the embodiments as disclosed herein. The network apparatus (201) includes a memory (203), a processor (204), and a network apparatus controller (205). The processor (204) coupled to the memory (203). The network apparatus controller (205) coupled to the memory (203) and the processor (204). The network apparatus controller (205) creates the first slice information list for the first slice group and the second slice information list for the second slice group. The first slice information list and the second slice information list include information to identify at least one of the allowed cell list or the excluded cell list. The network apparatus controller (205) sends the first slice information list and second slice information list in the broadcast signaling to the UE (102).

In an embodiment, the network apparatus controller (205) creates the second slice information list includes the list of PCI ranges and the index associated with the list of PCI ranges. The network apparatus controller (205) determines the first slice information list includes the index associated with the list of PCI ranges. When the index of the first slice information list is equal to the index in the second slice information list, the allowed cell list or the excluded cell list is the same for the first slice group and the second slice group. Further, the network apparatus controller (205) sends the first slice information list and the second slice information list in the broadcast signaling.

In another embodiment, the network apparatus controller (205) creates the second slice information list that includes the list of PCI ranges and the slice group identifier. The network apparatus controller (205) determines the first slice information list that includes a mapped slice group identifier. When the mapped slice group identifier is equal to the slice group identifier of the second slice group, the allowed cell list or the excluded cell list is the same for the first slice group and second slice group. Further, the network apparatus controller (205) sends the first slice information list and the second slice information list in the broadcast signaling.

In another embodiment, the network apparatus controller (205) creates the second slice information list that includes the list of PCI ranges, and the tracking area identity. The network apparatus controller (205) creates the first slice information list when the allowed cell list or the excluded cell list is same for the first slice group and second slice group. The first slice information list includes the tracking area identity. Further, the network apparatus controller (205) sends the first slice information list and the second slice information list in the broadcast signaling.

In another embodiment, the network apparatus controller (205) prioritizes the slice-based cell and creates the first slice information list and the second slice information list. The first slice information list or the second slice information list includes the serving frequency and the allowed cell list or the excluded cell list includes the serving cell. Further, the network apparatus controller (205) sends the first slice information list or the second slice information list in the frequency to the UE (102) for reselecting the slice-based cell.

The network apparatus controller (205) is implemented by processing circuitry such as logic gates, integrated circuits, microprocessors, microcontrollers, memory circuits, passive electronic components, active electronic components, optical components, hardwired circuits, or the like, and optionally be driven by firmware. The circuits for example, be embodied in one or more semiconductor chips, or on substrate supports such as printed circuit boards and the like.

At least one of the plurality of modules/components of the network apparatus controller (205) is implemented through an AI model. A function associated with the AI model is performed through the memory (203) and the processor (204). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired char-acteristic is made. The learning is performed in a device itself in which AI according to an embodiment is performed, and/or is implemented through a separate server/system.

The AI model consist of a plurality of neural network layers. Each layer has a plurality of weight values and performs a layer operation through calculation of a previous layer and an operation of a plurality of weights. Examples of neural networks include, but are not limited to, CNN, DNN, RNN, RBM, DBN, BRDNN, GAN, and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

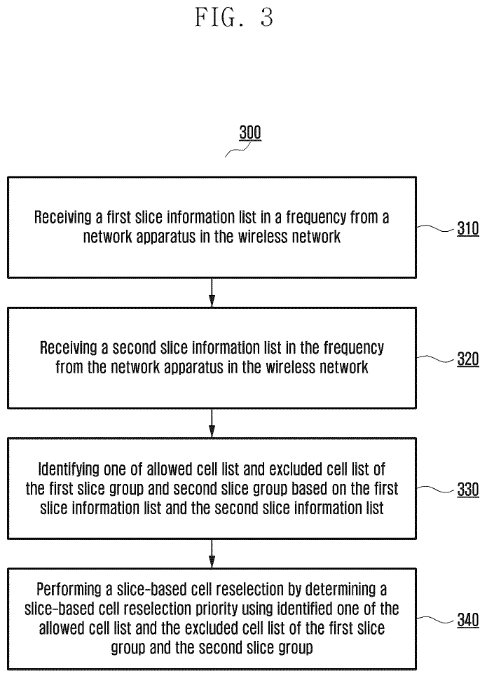

FIG. 3 is a flow chart (300) illustrating a method for performing the slice-based cell reselection, according to the embodiments as disclosed herein.

At 310, the method includes receiving a first slice information list in a frequency from the network apparatus (201) in the wireless network. The first slice information list includes information to identify the list of cells of the first slice group.

At 320, the method includes receiving a second slice information list in the frequency from the network apparatus in the wireless network. The second slice information list includes the information to identify the list of cells of the second slice group.

At 330, the method includes identifying the allowed cell list or excluded cell list of the first slice group and the second slice group based on the first slice information list and the second slice information list.

At 340, the method includes performing a slice-based cell reselection by determining a slice-based cell reselection priority using identified allowed cell list or the excluded cell list of the first slice group and the second slice group.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

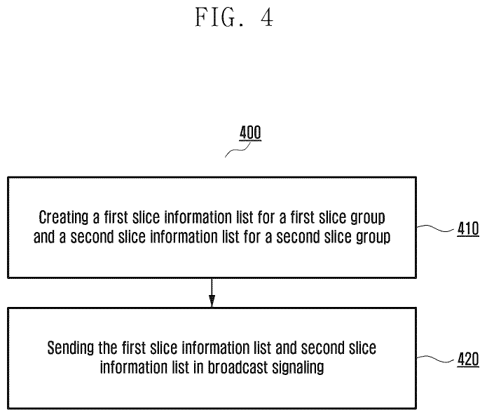

FIG. 4 is a flow chart (400) illustrating a method for sending a slice information list, according to the embodiments as disclosed herein.

At 410, the method includes creating the first slice information list for the first slice group and the second slice information list for the second slice group.

At 420, the method includes sending the first slice information list and the second slice information list in the broadcast signaling.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The term “slice information list” is a “first slice information list” or “second slice information list” in the specification.

In the embodiments, a slice availability PCI list for PCI lists that provide sliceAllowCellList and sliceExcludeCellList.

In an embodiment, the method for receiving list of PCI ranges that represents the slice availability.

The UE (102) receives the list of PCI ranges and the index associated with the list of PCI ranges for the slice group to indicate the slice availability. This list of PCI ranges and the index are received in the second slice information list of the frequency, for example, the slice availability PCI List or any sub-Information Elements (IEs).

In an embodiment, the UE (102) receives the same index without the associated list of PCI ranges in the first slice information list (i.e., in slice availability list) for additional slice groups of the same frequency. The UE (102) considers the list of PCI ranges in the slice information list for these additional slice groups as per the list of PCI ranges associated to the index, as received in the slice group where both index and the list of PCI ranges are received.

For example, the UE (102) received index1 in the slice availability PCI list for a slicegroup1 associated to PCI-rangelist1. When the UE (102) receives only index1 in the slice availability PCI list for a slicegroup2, the UE (102) considers the cells within PCI-rangelist1 as the cells in sliceAllowCellList or sliceExcludeCellList for the slicegroup2.

An example specification including the proposed changes is given below:

| | |
|---|---|
| SliceInformationList-r17 ::= | SEQUENCE (SIZE |

(1..maxSliceInformation-r17)) OF SliceInformation-r17

| | |
|---|---|
| SliceInformation-r17 ::= | SEQUENCE { |
| sliceGroupID-r17 | SliceGroupID-r17, |
| cellReselectionPriority-r17 | CellReselectionPriority |

OPTIONAL, -- Need R|

| | |
|---|---|
| cellReselectionSubPriority-r17 | CellReselectionSubPriority |

OPTIONAL, -- Need R

| | |
|---|---|
| sliceCellListNR-r17 | CHOICE { |
| sliceAllowCellListNR-r17 | SEQUENCE (SIZE (1..maxCellSlice- |

r17)) OF SliceCellListNR-r17,

| | |
|---|---|
| sliceExcludeCellListNR-r17 | SEQUENCE (SIZE (1..maxCellSlice- |

```
r17)) OF SliceCellListNR-r17,
  }
OPTIONAL, -- Need R
  ...
}
SliceCellListNR-r17 CHOICE {
sliceCellListIndex sliceCellListIndex OPTIONAL, --Need R
```

| | |
|---|---|
| SlicepCI-RangeList SlicePCI-RangeList | OPTIONAL --Need R |

}

| | |
|---|---|
| SlicePCI-RangeList ::= | SEQUENCE (SIZE (1..maxCellSlice-r17)) OF |

PCI-Range

| | |
|---|---|
| SliceGroupID-r17 ::= | BIT STRING (SIZE(8)) -- The size is FFS, |

depends on slice group granularity

TABLE 2
FreqPriorityListNRSlicing field descriptions

SliceCellListIndex
An index identifying a list of PCI-Range,
identified by SlicePCI-RangeList.
sliceAllowCellListNR
Indicates the list of allow-listed neighbouring
cells for slicing. If present, cells not listed
in this list do not support the corresponding
sliceGroup-frequency pair.
sliceCellListNR
Indicates the list of allow-list or exclude-listed
neighbour cells for slicing. If SliceCellListIndex
and SlicePCI-RangeList are included
in sliceCellListNR, sliceCellListIndex is
mapped to SlicePCI-RangeList. If SliceCellListIndex
is included without including slicePCI-RangeList,
UE the PCI-RangeList mapped to
sliceCellListIndex received for
any other slicegroup within this frequency
as the PCI-RangeList for this
sliceCellListNR.
sliceExcludeCellListNR
Indicates the list of exclude-listed neighbouring
cells for slicing. If present, cells not listed in this
list support the corresponding slice sliceGroup-frequency pair.

In an embodiment, the methods for the UE (102) to receive the PCI range based on the index as described in this invention is used in any scenario where the UE (102) receives the PCI range in broadcast signalling. In an example, these and other methods is used for providing the list of cells which are served by terrestrial network to the UE (102) which is camped on a cell served by Nonterritorial Network.

In an embodiment, the wireless network includes the index for the list of PCI ranges when all the cells in the list are mapped to the same tracking area. In another embodiment, the wireless network includes the index for the list of PCI ranges belonging to multiple tracking areas, when all those tracking areas have the same slice availability.

For example, the case of four neighbour cells cell1, cell2, cell3, cell4 support slicegroup1, slicegroup2 and slicegroup3 and two neighbour cells cell5, cell6 support slice group 1 and slice group 4. Each PCI range in this example contains a single PCI. cell1, cell2, cell3 etc. represent the PCI range also. The UE (102) receives the information (given below) in the slice information list. Only slicegroup Id and the slice availability PCI lists are shown in the example.
SliceInformation: Slicegroup-ID: 1, sliceAllowCellList: [sliceCellListIndex=1 PCI-RangeList {cell1, cell2, cell3, cell4}] [sliceCellListIndex=2 PCI-RangeList {cell5, cell6}]
SliceInformation: Slicegroup-ID: 2, sliceAllowCellListNR-r17:
[sliceCellListIndex=1]
SliceInformation: Slicegroup-ID: 3, sliceAllowCellListNR-r17:
[sliceCellListIndex=1]
SliceInformation: Slicegroup-ID: 4, sliceAllowCellListNR-r17:
[sliceCellListIndex=2]

For slicegroup-ID 2 and slice group ID 3, the UE (102) considers cell1, cell2, cell3 and cell4 as supporting both the slice groups as the same slicecellIndex 1 is mapped to {cell1, cell2, cell3, cell4} in slice group with ID 1.

For slicegroup-ID 4, the UE (102) considers cell5 and cell6, as supporting the slice group 4 as the same slicecellIndex 2 is mapped to {cell5, cell6} in slice group with ID 1.

In an embodiment, the index defined in the allowcellList of one slice group is also used in excludecellList for a different slicegroup within the same frequency to indicate the same PCI range.

In another embodiment, the UE (102) receives a list, for example SliceCellList including either the PCI range and the index associated to the PCI-range or only the index within the slice information, for example, in the slice availability list. When the UE (102) receives only the index for a PCI range in the SliceCellList for the slice group, the UE (102) considers the same PCI-range associated to any other slice group within this frequency where both PCI range and the same index are provided as applicable for this slice group.

| | |
|---|---|
| SliceInformationList-r17 ::= | SEQUENCE (SIZE |

(1..maxSliceInformation-r17)) OF SliceInformation-r17

| | |
|---|---|
| SliceInformation-r17 ::= | SEQUENCE { |
| sliceGroupID-r17 | SliceGroupID-r17, |
| cellReselectionPriority-r17 | CellReselectionPriority |

OPTIONAL, -- Need R

| | |
|---|---|
| cellReselectionSubPriority-r17 | CellReselectionSubPriority |

OPTIONAL, -- Need R

| | |
|---|---|
| sliceCellListNR-r17 | CHOICE { |
| sliceAllowCellListNR-r17 | SliceCellListNR-r17, |
| sliceExcludeCellListNR-r17 | SliceCellListNR-r17 |

```
  }
OPTIONAL, -- Need R
  ...
}
```

| | |
|---|---|
| SliceGroupID-r17 ::= | BIT STRING (SIZE(8)) -- The size is FFS, |

depends on slice group granulartiy

| | |
|---|---|
| SliceCellListNR-r17 ::= | SEQUENCE (SIZE (1..maxCellSlice-r17)) OF PCI- |

RangeElement2-r17

| | |
|---|---|
| PCI-RangeElement2-r17 | SEQUENCE { |
| Pci-RangeIndex | PCI-RangeIndex, |
| Pci-Range | PCI-Range |

OPTIONAL, -- Need X
}
-- TAG-FREQPRIORITYLISTNRSLICING-STOP
-- ASN1STOP

For example, the case of three neighbour cells cell1, cell2, cell3, cell4 support slicegroup1, slicegroup2 and slicegroup3 and two neighbour cells cell5, cell6 support slice group 1 and slice group 4.

Cell1, Cell2, Cell3, Cell4 is having PCI range {start 100, range 4}.

Cell5, Cell6 is having PCI range {start 104, range 2}

SliceInformation: Slicegroup-ID: 1, sliceAllowCellList: [PCI-RangeIndex 1 PCI-Range {start 100, range 4}] [PCI-RangeIndex 2, PCI-Range {start 104, range 2}]

SliceInformation: Slicegroup-ID: 2, sliceAllowCellListNR-r17: [PCI-RangeIndex 1]

SliceInformation: Slicegroup-ID: 3, sliceAllowCellListNR-r17: [PCI-RangeIndex 1]

SliceInformation: Slicegroup-ID: 4, sliceAllowCellListNR-r17: [PCI-RangeIndex 2]

For slicegroup-ID 2 and slice group-ID 3, the UE (102) considers cell1, cell2, cell3 and cell4 as supporting both the slice groups as the same PCI-RangeIndex 1 is mapped to their PCI range {start 100, range 4} in slice group-ID 1. For slicegroup-ID 4, the UE (102) considers cell5 and cell6, as supporting the slice group 4 as the same PCI-RangeIndex 2 is mapped to their PCI range {start 100, range 4} in slice group-ID 2.

In another embodiment, the UE (102) receives the information from the wireless network that the PCI lists indicating the slice availability for the slice group (for example, slicegroup1) in the frequency are identical to that of another slice group (for example, slicegroup2), i.e., the UE (102) provided with the slice availability PCI list for one slice group and the wireless network request the UE (102) to use the same slice availability list for another slicegroup by just providing the slice group ID of the slice group (mapped slicegroup ID) which has received the slice availability PCI list.

In an embodiment, the UE (102) receives the list of cells (for example, as cell identifier, PCI range or index) in the slice availability PCI list for one slicegroup (for example, slicegroup 1). For other slice group (for example, slicegroup 2), the UE (102) does not receive the list of cells, but receives the information that the mapped slice group ID for the slice availability list is slicegroup1. Both the slice groups in the same frequency. This information IS received by the UE (102) through the IE in the slice information within RRC message like SIB16 or RRC Release.

| | |
|---|---|
| SliceInformationList-r17 ::= | SEQUENCE (SIZE |

(1..maxSliceInformation-r17)) OF SliceInformation-r17

| | |
|---|---|
| SliceInformation-r17 ::= | SEQUENCE { |
| sliceGroupID-r17 | SliceGroupID-r17, |
| cellReselectionPriority-r17 | CellReselectionPriority |

OPTIONAL, -- Need R

| | |
|---|---|
| cellReselectionSubPriority-r17 | CellReselectionSubPriority |

OPTIONAL, -- Need R

| | |
|---|---|
| sliceCellListNR-r17 | CHOICE { |
| mappedSliceGroupId-r17 | SliceGroupID-r17, |
| sliceAllowCellListNR-r17 | SliceCellListNR-r17, |
| sliceExcludeCellListNR-r17 | SliceCellListNR-r17 |

```
  }
OPTIONAL, -- Need R
  ...
}
```

| | |
|---|---|
| SliceGroupID-r17 ::= | BIT STRING (SIZE(8)) -- The size is FFS, |

depends on slice group granulartiy

| | |
|---|---|
| SliceCellListNR-r17 ::= | SEQUENCE (SIZE (1..maxCellSlice-r17)) OF PCI- |

Range
-- TAG-FREQPRIORITYLISTNRSLICING-STOP
-- ASN1STOP

The UE (102) uses the slice availability PCI list in slicegroup 1 for slice group 2 also within the same frequency.

For example, the case of three neighbour cells cell1, cell2, cell3, cell4 support both slicegroup1 slicegroup2. For slicegroup1, the UE (102) receives the PCI-range rep-resenting all the cells {cell1, cell2, cell3 and cell4} in either the allowed cell list or the excluded cell list while for slicegroup2, the UE (102) receives the mapped Slice Group ID is slicegroup1. The UE (102) considers {cell1, cell2, cell3 and cell4} as the allowed cell list or the excluded cell list.

TABLE 3
FreqPriorityListNRSlicing field descriptions

SliceCellListIndex
An index identifying a list of PCI-Range,
identified by SlicePCI-RangeList.
sliceAllowCellListNR
Indicates the list of allow-listed neighbouring
cells for slicing. If present, cells not
listed in this list do not support the
corresponding sliceGroup-frequency pair.
sliceCellListNR
Indicates the list of allow-list or exclude-
listed neighbour cells for slicing
mappedSliceGroupIdIndicates the slice group
id whose allow-list of exclude-listed
neighbour cells for slicing are same as this slicegroupId.
sliceExcludeCellListNR
Indicates the list of exclude-listed neighbouring
cells for slicing. If present, cells not
listed in this list support the corresponding
slice sliceGroup-frequency pair.

In another embodiment, the UE (102) receives Tracking Area Code (TAC) or the Tracking Area Identifier (TAI) associated with the slice groups. The UE (102) receives the PCI lists indicating slice availability along with the TAC/TAI for the slice group (for example, slicegroup1) and receives only the TAC/TAI for the slice availability PCI list in another slice group. The UE (102) uses the same PCI lists in the slice availability list of the slicegroup which received TAC/TAI mapped to the slice availability PCI list (i.e., slicegroup1) for other slice group associated to the same TAC/TAI and for which slice availability PCI lists are not explicitly provided.

| | |
|---|---|
| SliceInformationList-r17 ::= | SEQUENCE (SIZE |

(1..maxSliceInformation-r17)) OF SliceInformation-r17

| | |
|---|---|
| SliceInformation-r17 ::= | SEQUENCE { |

trackingAreaCode TrackingAreaCode OPTIONAL,

| | |
|---|---|
| sliceGroupID-r17 | SliceGroupID-r17, |
| cellReselectionPriority-r17 | CellReselectionPriority |

OPTIONAL, -- Need R

| | |
|---|---|
| cellReselectionSubPriority-r17 | CellReselectionSubPriority |

OPTIONAL, -- Need R

| | |
|---|---|
| sliceCellListNR-r17 | CHOICE { |
| sliceAllowCellListNR-r17 | SliceCellListNR-r17, |
| sliceExcludeCellListNR-r17 | SliceCellListNR-r17 |

```
  }
OPTIONAL, -- Need R
  ...
}
```

| | |
|---|---|
| SliceGroupID-r17 ::= | BIT STRING (SIZE(8)) -- The size is FFS, |

depends on slice group granulartiy

| | |
|---|---|
| SliceCellListNR-r17 ::= | SEQUENCE (SIZE (1..maxCellSlice-r17)) OF PCI- |

Range
-- TAG-FREQPRIORITYLISTNRSLICING-STOP
-- ASN1STOP

For example, the case of three neighbour cells cell1, cell2, cell3, cell4 support both slicegroup1 slicegroup2. For slicegroup1, the UE (102) receives the PCI-range rep-resenting all the cells {cell1, cell2, cell3 and cell4} in either allowed list or excluded list while for slicegroup2. The UE (102) receives the mapped slice group ID is slicegroup1. The UE (102) considers {cell1, cell2, cell3 and cell4} as the allowed or the excluded.

In an embodiment, the method for handling Slice specific prioritization with multiple PLMN. The UE (102) is configured with multiple slice information lists (sliceInformationList), each sliceInformationList associated to a PLMN ID. An example structure by which gNB can send the same to the UE is given below:

-- ASN1START
-- TAG-FREQPRIORITYLISTNRSLICING-START
FreqPriorityListNRSlicing-r17 ::= SEQUENCE (SIZE (0..maxFreq)) OF
FreqPriorityNRSlicing-r17

| | |
|---|---|
| FreqPriorityNRSlicing-r17 ::= | SEQUENCE { |
| PLMN | PLMN-ID |
| OPTIONAL, | -- Need R |
| sliceInformationList-r17 | SliceInformationList-r17 |
| OPTIONAL, | -- Need R |

...
}

When the UE (102) receives the different slice information lists mapped to the different PLMNs. The UE (102) applies slice information list mapped to the registered PLMN or the equivalent PLMN available in the serving cell for identifying the slice information (i.e., the UE (102) derives slice based cell reselection priorities using the sliceInformationList mapped to the REGISTERED PLMN or EQUIVALENT PLMN. The PLMN in the FreqPriorityNRSlicing includes the PLMN ID for the REGISTERED PLMN or the EQUIVALENT PLMN). In an embodiment, when both registered PLMN and equivalent PLMN are available, the UE (102) considers the registered PLMN for identifying the slice Information.

When the UE (102) is in camped normally state and the UE (102) supports slice-based cell reselection. The UE (102) derives re-selection priorities. The UE (102) consider the slice information associated with the registered PLMN or the equivalent PLMN (when per PLMN sliceInformation is available) for deriving reselection priorities for the slice-based cell reselection.

In an embodiment, the method for deriving cell reselection priority for the serving frequency. The UE (102) determines the slice-based cell reselection priority of the serving frequency by considering the list of slice groups supported by the serving cell rather than the list of slice groups supported by the serving frequency as broadcasted. This reselection priority is used until the highest ranked cell changes on the frequency, or new slice group information is received from non-access stratum (NAS).

In an embodiment, the UE (102) derives re-selection priorities for the slice-based cell re-selection according to the following rules:
Frequencies that support at least one prioritized slice group received from the NAS have higher re-selection priority than frequencies that support no prioritized slice groups.
Frequencies that support at least one slice group are prioritised in the order of the NAS-provided priority for the highest prioritised slice group of the frequency.
Among the frequencies that support the same highest prioritised slice group, the frequencies are prioritized in the order of their per slice group slices specific cell reselection priority.
Frequencies that support a prioritized slice group and that indicate per slice group sliceSpecificCellReselectionPriority have higher re-selection priority than frequencies that support this prioritized slice group without indicating per slice group slice specific cell reselection priority.
Frequencies that support no prioritized slice group are prioritized in the order of their cellReselectionPriority;

The UE (102) NAS receives the list of the slice groups supported by the serving cell during NAS registration procedure and gives this information to UE RRC.UE RRC also receive the list of slice groups supported by the serving cell in the broadcast signalling. The list of slice groups supported by the serving cell is received by NR UE in system information messages such as the SIB16. In an embodiment, the gNB always includes the serving cell NSAG availability in the SIB 16. The UE (102) performs slice-based cell reselection without considering serving cell's NSAG availability initially, but after performing first set of measurements and evaluations, it switch to performing slice based cell reselection based on the serving cell's NSAG availability and for a certain duration.

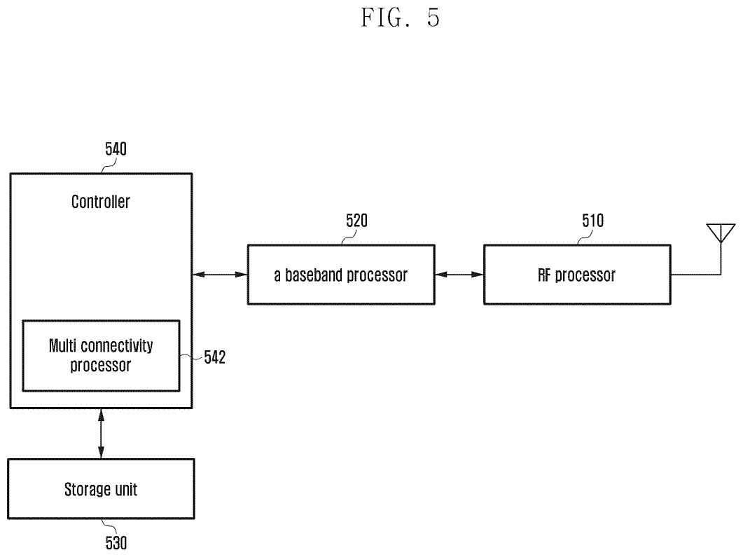

The structure of the UE to which embodiments of the disclosure can be applied is illustrated in FIG. 5.

Referring to FIG. 5, the UE includes a radio frequency (RF) processor 510, a baseband processor 520, a storage unit 530, and a controller 540.

The RF processor 510 performs a function for transmitting and receiving a signal through a wireless channel, such as band conversion and amplification of a signal. That is, the RF processor 510 up-converts a baseband signal provided from the baseband processor 520 into an RF band signal, transmits the RF band signal through an antenna, and then down-converts the RF band signal received through the antenna into a baseband signal. For example, the RF processor 510 may include a transmission filter, a reception filter, an amplifier, a mixer, an oscillator, a digital-to-analog converter (DAC), an analog-to-digital converter (ADC), and the like. Although FIG. 5 illustrates only one antenna, the UE may include a plurality of antennas. In addition, the RF processor 510 may include a plurality of RF chains. Moreover, the RF processor 510 may perform beamforming. For the beamforming, the RF processor 510 may control a phase and a size of each signal transmitted/received through a plurality of antennas or antenna elements. The RF processor may perform MIMO and receive a plurality of layers when performing the MIMO operation. The RF processor 510 may appro-priately configure a plurality of antennas or antenna elements according to the control of the controller to perform reception beam sweeping or control a direction of a reception beam and a beam width so that the reception beam corresponds to a transmission beam.

The baseband processor 520 performs a function for a conversion between a baseband signal and a bitstream according to a physical layer standard of the system. For example, when data is transmitted, the baseband processor 520 generates complex symbols by encoding and modulating a transmission bitstream. Further, when data is received, the baseband processor 520 reconstructs a reception bitstream by demodulating and decoding a baseband signal provided from the RF processor 510. For example, in an orthogonal frequency division multiplexing (OFDM) scheme, when data is transmitted, the baseband processor 520 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 520 divides the baseband signal provided from the RF processor 510 in the unit of OFDM symbols, reconstructs the signals mapped to the subcarriers through a fast Fourier transform (FFT) operation, and then reconstructs a reception bitstream through demodulation and decoding.

The baseband processor 520 and the RF processor 510 transmit and receive signals as described above. Accordingly, the baseband processor 520 and the RF processor 510 may be referred to as a transmitter, a receiver, a transceiver, or a communication unit. Further, at least one of the baseband processor 520 and the RF processor 510 may include a plurality of communication modules to support a plurality of different radio access technologies. In addition, at least one of the baseband processor 520 and the RF processor 510 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 530 stores data such as basic program, an application, and setting information for the operation of the UE. The storage unit 530 provides the stored data according to a request from the controller 540.

The controller 540 controls the overall operation of the UE. For example, the controller 540 transmits/receives a signal through the baseband processor 520 and the RF processor 510. In addition, the controller 540 may record data in the storage unit 530 and read the data. To this end, the controller 540 may include at least one processor. For example, the controller 540 may include a communication processor (CP) that performs a control for communication, and an application processor (AP) that controls a higher layer such as an application program.

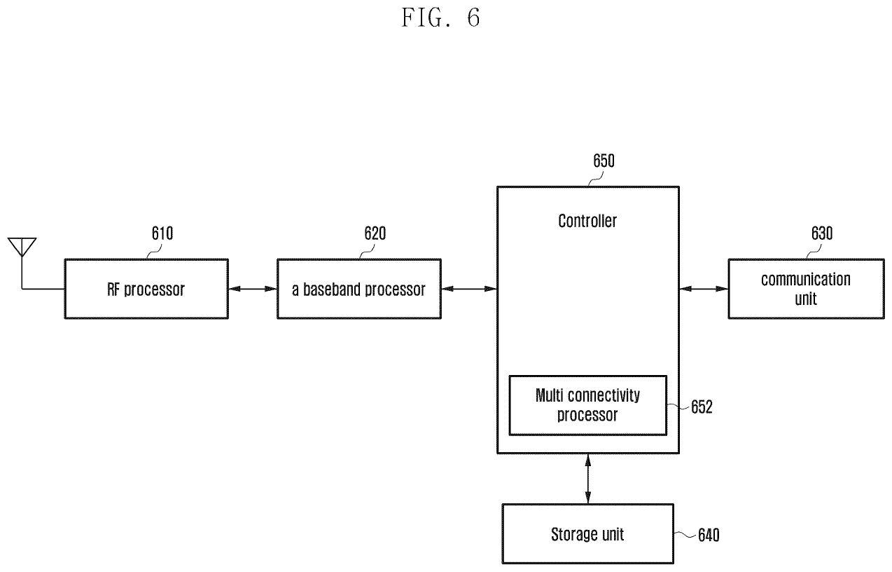

FIG. 6 illustrates a block diagram of a TRP in a wireless communication system to which embodiments of the disclosure can be applied.

As illustrated in FIG. 6, the base station includes an RF processor 610, a baseband processor 620, a backhaul communication unit 630, a storage unit 640, and a controller 650.

The RF processor 610 performs a function for transmitting and receiving a signal through a wireless channel, such as band conversion and amplification of a signal. That is, the RF processor 610 up-converts a baseband signal provided from the baseband processing unit 620 into an RF band signal and then transmits the converted signal through an antenna, and down-converts an RF band signal received through the antenna into a baseband signal. For example, the RF processor 610 may include a transmission filter, a reception filter, an amplifier, a mixer, an oscillator, a DAC, and an ADC. Although FIG. 6 illustrates only one antenna, the first access node may include a plurality of antennas. In addition, the RF processor 610 may include a plurality of RF chains. Moreover, the RF processor 610 may perform beamforming. For the beamforming, the RF processor 610 may control a phase and a size of each of the signals transmitted and received through a plurality of antennas or antenna elements. The RF processor may perform a downlink MIMO operation by transmitting one or more layers.

The baseband processor 620 performs a function of performing conversion between a baseband signal and a bitstream according to a physical layer standard of the first radio access technology. For example, when data is transmitted, the baseband processor 620 generates complex symbols by encoding and modulating a transmission bitstream. Further, when data is received, the baseband processor 620 reconstructs a reception bitstream by demodulating and decoding a baseband signal provided from the RF processor 610. For example, in an OFDM scheme, when data is transmitted, the baseband processor 620 may generate complex symbols by encoding and modulating the transmission bitstream, map the complex symbols to subcarriers, and then configure OFDM symbols through an IFFT operation and CP insertion. In addition, when data is received, the baseband processor 620 divides a baseband signal provided from the RF processor 610 in units of OFDM symbols, recovers signals mapped with sub-carriers through an FFT operation, and then recovers a reception bitstream through demodulation and decoding. The baseband processor 620 and the RF processor 610 transmit and receive signals as described above. Accordingly, the baseband processor 620 and the RF processor 610 may be referred to as a transmitter, a receiver, a transceiver, or a communication unit.

The communication unit 630 provides an interface for communicating with other nodes within the network.

The storage unit 640 stores data such as a basic program, an application, and setting information for the operation of the MeNB. Particularly, the storage unit 2040 may store information on bearers allocated to the accessed UE and the measurement result reported from the accessed UE. Further, the storage unit 640 may store information on a reference for determining whether to provide multiple connections to the UE or stop the multiple connections. In addition, the storage unit 640 provides data stored therein according to a request from the controller 650.

The controller 650 controls the overall operation of the MeNB. For example, the controller 650 transmits and receives a signal through the baseband processor 620 and the RF processor 610 or through the backhaul communication unit 630. In addition, the controller 650 may record data in the storage unit 640 and read the data. To this end, the controller 650 may include at least one processor.

Although the present disclosure has been described with various embodiments, various changes and modifications may be suggested to one skilled in the art. It is intended that the present disclosure encompass such changes and modifications as fall within the scope of the appended claims.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless communication system, the method comprising:
receiving, from a network apparatus, system information (SI) including slice information for a frequency, wherein the slice information includes a cell list associated with a network slice group;
identifying whether a cell in the frequency supports a first network slice group;
in case that the cell does not support the first network slice group, identifying a cell reselection priority for the frequency associated with a second network slice group supported by the cell based on the cell list associated with the network slice group; and
performing a cell reselection, based on the identified cell reselection priority for the frequency.

2. The method of claim 1,
wherein in case that the cell list is a slice allowed cell list, the slice allowed cell list includes a serving cell.

3. The method of claim 1,
wherein in case that the cell list is a slice excluded cell list, the slice excluded cell list includes a serving cell.

4. The method of claim 1,
wherein the slice information includes at least one first information on an identifier of the network slice group, second information on a cell reselection priority for the network slice group, or third information on a cell reselection sub priority for the network slice group.

5. The method of claim 1,
wherein the SI is a system information block (SIB) 16.

6. A method performed by a network apparatus in a wireless communication system, the method comprising:
transmitting, to a user equipment (UE), system information (SI) including slice information for a frequency,
wherein the slice information includes a cell list associated with a network slice group,
wherein the cell list associated with the network slice group is associated with a cell reselection priority for the frequency, and
wherein a cell reselection is performed based on the cell reselection priority.

7. The method of claim 6,
wherein in case that the cell list is a slice allowed cell list, the slice allowed cell list includes a serving cell.

8. The method of claim 6,
wherein in case that the cell list is a slice excluded cell list, the slice excluded cell list includes a serving cell.

9. The method of claim 6,
wherein the slice information includes at least one first information on an identifier of the network slice group,
second information on a cell reselection priority for the network slice group or third information on a cell reselection sub priority for the network slice group.

10. The method of claim 6,
wherein the SI is a system information block (SIB) 16.

11. A user equipment (UE) in a wireless communication system, the UE comprising:
a transceiver; and
a controller coupled with the transceiver, and configured to:
receive, from a network apparatus, system information (SI) including slice information for a frequency, wherein the slice information includes a cell list associated with a network slice group,
identify whether a cell in the frequency supports a first network slice group,
in case that the cell does not support the first network slice group, identify a cell reselection priority for the frequency associated with a second network slice group supported by the cell based on the cell list associated with the network slice group; and
perform a cell reselection, based on the identified cell reselection priority for the frequency.

12. The UE of claim 11,
wherein in case that the cell list a slice allowed cell list, the slice allowed cell list includes a serving cell.

13. The UE of claim 11,
wherein in case that the cell list is a
slice excluded cell list, the slice excluded cell list includes a serving cell.

14. The UE of claim 11,
wherein
the slice information includes at least one first information on an identifier of the network slice group second information on a cell reselection priority for the network slice group, or third information on a cell reselection sub priority for the network slice group.

15. The UE of claim 11, wherein the SI is a system information block (SIB) 16.

16. A network apparatus in a wireless communication system, the network apparatus comprising:
a transceiver; and
a controller coupled with the transceiver, and configured to:
transmit, to a user equipment (UE), system information (SI) including slice information for a frequency,
wherein the slice information includes a cell list associated with a network slice group,
wherein the cell list associated with the network slice group is associated with a cell reselection priority for the frequency, and
wherein a cell reselection is performed based on the cell reselection priority.

17. The network apparatus of claim 16,
wherein in case that the cell list is a slice allowed cell list, the slice allowed cell list includes a serving cell.

18. The network apparatus of claim 16,
wherein in case that the cell list is a slice excluded cell list, the slice excluded cell list includes a serving cell.

19. The network apparatus of claim 16,
wherein the slice information includes at least one first information on an identifier of the network slice group, second information on a cell reselection priority for the network slice group, or third information on a cell reselection sub priority for the network slice group.

20. The network apparatus of claim 16,
wherein the SI is a system information block (SIB) 16.
